(19) United States
(12) Patent Application Publication
(10) Pub. No.: US 2005/0257419 A1
(43) Pub. Date: Nov. 24, 2005

(54) Float system with toroidal adjustment

(76) Inventor: Kurt Francis Weeda, Braham, MN (US)

Correspondence Address: Roger L. Belfay, 829 Tuscarora Avenue, Saint Paul, MN, 55102, US

(21) Appl. No.: 10/852,494

(22) Filed: May 24, 2004

(51) Int. Cl. A01K 93/00

(52) U.S. Cl. 43/44.87

(57) ABSTRACT

The Float System, with Toroidal Adjustment, is a float system, comprising: a hook member having an open end exposing a cavity and an engaging end for releasably engaging a fishing line; an elongated member having a lower end and an upper end, wherein said lower end of said elongated member is secured within said cavity of said hook member; a first bouyant member having a toroidal structure positioned about said elongated member, wherein said first bouyant member may be repositioned along said elongated member. The system may include a weight in the hook member, a signaling device, a plurality of holes in the hook member for attaching additional weights or other devices. The system may be made from resilient materials and the elongated member may be buoyant. The float system may be made from cuttable materials. The slit in the hook member may be curved.

The Float system with Toroidal Adjustment comprises a hook member having an open end exposing a cavity and an engaging end for releasably engaging a fishing line, an elongated member having a lower end and an upper end, wherein said lower end of said elongated member is secured within said cavity of said hook member, a first bouyant member having a toroidal structure positioned about said elongated member, wherein said first bouyant member may be repositioned along the elongated member.

### CROSS REFERENCE TO RELATED APPLICATIONS

There are no applications related to this application.

### STATEMENT REGARDING FEDERAL SPONSORSHIP

No invention claimed in this application was made under Federally sponsored research or development.

### BACKGROUND OF INVENTION

Float devices have been in use for many years. Existing float systems provide flotation to various hooks and other devices so that by adjusting the length of line between float and lure the depth of the hook or lure may be established.

A second function that float systems provide is an indication that a fish is on the line by momentarily disappearing under the water's surface when such a fish takes the hook and swims away pulling on the line as it does so. In some cases fish will nibble on the bait and cause the float to vibrate or wiggle. In all these cases the placement of the hook and bait in the horizontal and vertical directions under the water is the primary purpose of the float system.

A large above surface cross section of the float will cause the horizontal position to change by wind action. The weight of the hooks and weights used to set the depth of the hooks and lures can vary substantially from use to use. The desire to have a float stay in place and not drift in the wind, causes the user to desire a minimal cross section of the float to be visible above the water. The need to see the float and it motions associated with fish taking the bate or nibbling causes the user to desire a larger cross section to enhance visibility. These often conflicting objectives give rise to the need for an adjustable float which can be adjusted by the user to achieve the optimal tradeoff between these objectives.

Some floats provide fixed profiles and therefore permit the adjustment of the above water profile only by adding or deleting weights to the submerged portion of the line. These floats tend to have a wide profile and therefore provide a large amount of surface profile when they are adjusted to permit higher elevation above the surface of the water for visibility purposes.

In some float systems the above surface profile is adjusted by cutting away material from the float making the float unsuitable for changed conditions in the future or unusable if too much material is removed while attempting to adjust for current conditions.

### BRIEF SUMMARY OF THE INVENTION

It is an object of the present invention to overcome the disadvantages of current float systems by providing a float system with a small area exposed above the surface of the water in proportion to the height above the water provided for visibility. It is a further objective of this invention to provide a device, which is adjustable for conditions as described above without being consumed by the act of adjustment.

This is accomplished by providing a relatively broad flotation ring, or torus, slideably surrounding a central core. The broad floatation ring provides a relatively broad base which, through weighting of the float, line, and hook assembly can be made to float in a nearly submerged position while the central core's position relative to the toroidal floatation ring is adjusted to provide the optimal exposure of the central core for wind and visibility conditions. In addition the overall amount of central core needed to provide a given height is less than other floats because the larger diameter toroidal ring provides a more stable base allowing the central core to remain in a more vertical position.

### BRIEF DESCRIPTION OF THE DRAWINGS

FIG. 1 is a perspective drawing of the Float system with toroidal adjustment.

FIG. 2 is a front view of the Float system with toroidal adjustment.

FIG. 3 is a section view of the Float system with toroidal adjustment.

FIG. 4 is a section view hook member of the Float system with toroidal adjustment.

FIG. 5 is a front view of the hook member of the Float system with toroidal adjustment.

FIG. 6 is an exploded view of the Float system with toroidal adjustment.

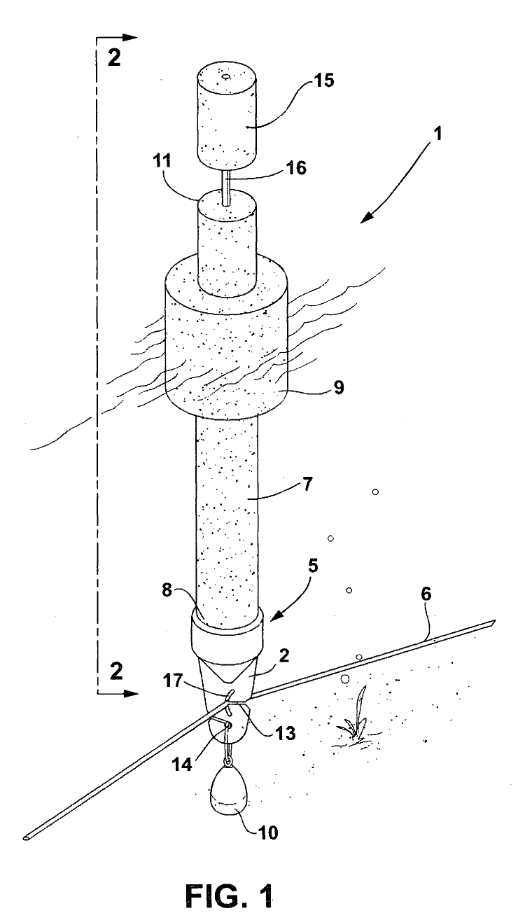

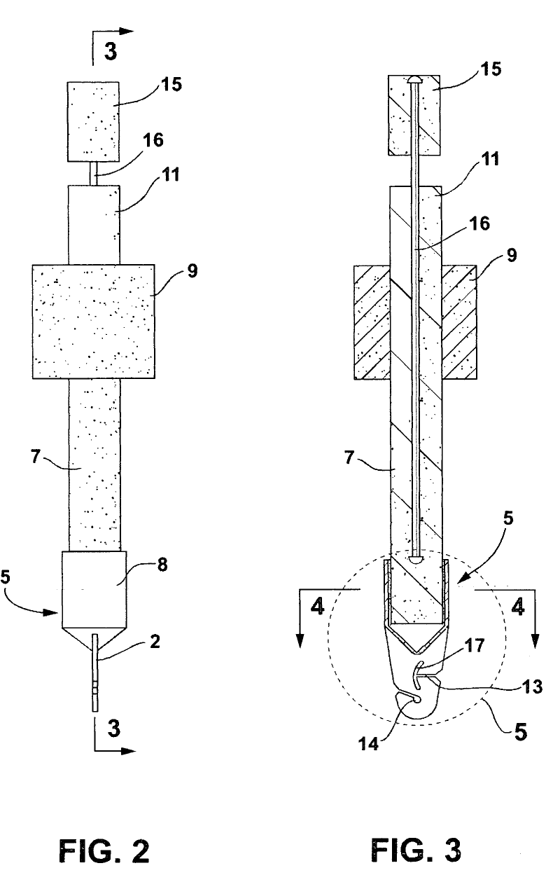

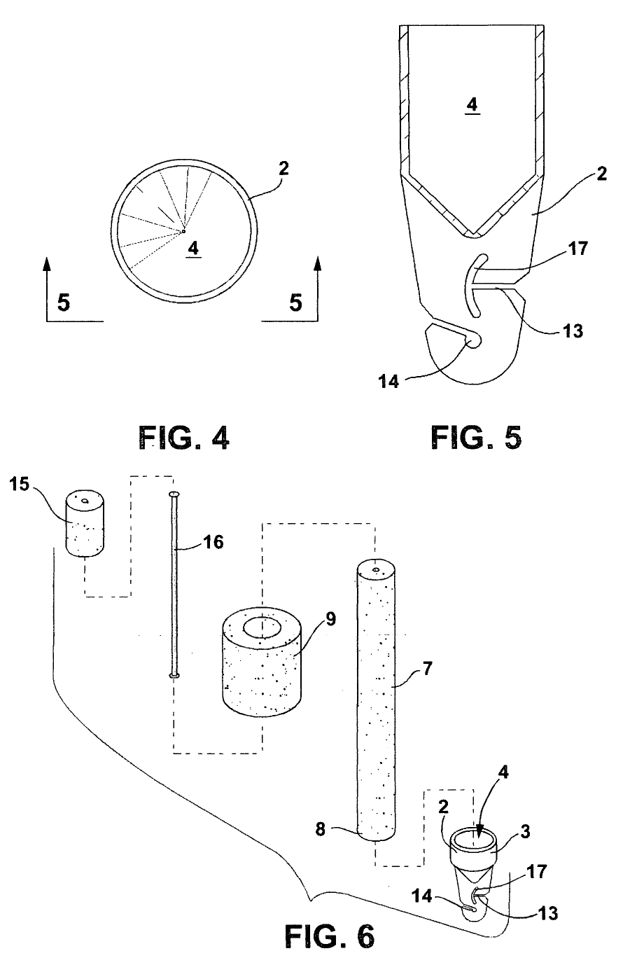

### DETAILED DESCRIPTION

The Float system 1 with Toroidal Adjustment comprises a hook member 2 having an open end 3 exposing a cavity 4 and an opposed engaging end 5 for releasably engaging a fishing line 6, an elongated member 7 having a lower end 8 and an upper end, wherein said lower end 8 of said elongated member 7 is secured within said cavity 4 of said hook member 2, a first bouyant member 9 having a toroidal structure positioned about said elongated member 7, wherein said first bouyant member 9 may be repositioned along the elongated member 7. Each part of The Float system 1 with Toroidal Adjustment may be made from resilient material to facilitate removal of ice when used in ice fishing or other occasions when ice build up on the float system 1 may occur. The first buoyant member 9 may be constructed of any buoyant material with low enough specific gravity and high enough volume to permit the entire float to float while supporting first weights 10, hooks, and other devices attached either via fishing line 6 or directly to the float system 1. Alternatively the buoyant member 9 may be constructed of an material with a hollow interior providing sufficient buoyancy to permit the entire float system 1 to float while supporting first weights 10, hooks, and other devices attached either via fishing line 6 or directly to the float system 1. The first buoyant member 9 includes a hole through which the elongated member 7 is passed. The hole in the buoyant member is created of such a size that the elongated member 7 fits into the hole loosely enough to allow the position of the buoyant member 9 to be adjusted along the length of the elongated member 7 by the user but tightly enough to permit the buoyant member 9 to be held in the position established by the user. Through this means the user may adjust the relative height of the highest portion of the float system 1 above the water in which it floats to accommodate local conditions. The hook member 2 may be constructed of resilient material, which may or may not be buoyant. The hook member 2 includes a cavity 4 for insertion and fastening of the elongated member 7. This cavity 4 may be of such a size as to permit inclusion of a second weight. At the end opposite 11 the cavity 4 the hook member 2 includes a slit 13 for fastening a fishing line 6. This slit 13 may be curved or tapered or both curved and tapered to assure the hook member 2 adheres or grasps sufficiently to a fishing line 6 passed through the slit 13 to maintain the float system's 1 position along the line 6 without tying the line 6 to the float system 1. The slit 13 may be open to permit insertion of the line 6 or it may form a closed loop through which the line 6 can be threaded. The hook member 2 may contain one or more holes 14 for attaching first weights 10 or other devices.

The elongated member 7 of the Float system 1 with Toroidal Adjustment may be fabricated using buoyant or non-buoyant material. The overall weight and volume of the float system 1 will determine its ability to float and support first weights 10, hooks, and other devices the user chooses to attach to the float system 1. The length of the line 6 used to attach them to the float system 1 determines the depth at which the attached hooks and other devices are suspended. The amount of the float system 1 showing above the surface of the water is determined by the position of the buoyant member along the elongated member 7. The ability of the float system 1 to float and support any attached devices is determined by: 1) the overall weight of the float system 1 including submerged attached devices, and 2) the overall volume of the float system 1 and attached first weights 10 or devices. The volume and specific gravity of the buoyant member 9 is selected to assure that the float system 1 and attachments will float and keep the attachments at the user-selected depth.

The Float system 1 with Toroidal Adjustment may include a signaling device 15, such as a flag or other device to alert the user as to the position of the Float system 1 or the submergence of the float system 1 possibly in response to a fish or other aquatic animal becoming attached to a hook or other device attached to the float system 1. The signaling device 15 may be attached to the elongated member 7 by any suitable means such as a slidebly attached central member 16. The signaling device 15 may include any device which provides increased visibility to the user such as a flag or section of the same characteristics as the elongated member 7.

The hook member 2 of the float system 1 may include ajaw extending from a body of said hook member 2 and a slot 17 within the jaw and a slit 13 extending into a side of the jaw for affixing line 6 to the hook member 2 and thereby to the float system 1. The slit 13 may be tapered to permit free passage of a line 6 until the line 6 is grasped at the narrow end of the slit 13. The slit 13 may be a closed loop within the hook member 2 and made of a cuttable material so that the user may sever a portion of the loop thereby creating a slit 13 permit passage of a line 6 into the slot 17.

1. A float system, comprising:
(a) a hook member having an open end exposing a cavity and an opposed engaging end for releasably engaging a fishing line;
(b) an elongated member having a lower end, and an upper end, wherein said lower end of said elongated member is secured within said cavity of said hook member;
(c) a first bouyant member having a toroidal structure positioned about said elongated member, wherein said first bouyant member may be repositioned along said elongated member.

2) The float system of claim 1 further comprising a second weight member positioned within said hook member.

3) The float system of claim 1 further comprising a second weight member positioned within the open end of said hook member.

4) The float system of claim 1 further comprising a signaling member attached to said upper end of said elongated member.

5) The float system of claim 1 wherein said hook member further comprises: a jaw extending from a body of said hook member; a slot within said jaw; and a slit extending into a side of said jaw connecting to said slot.

6) The float system of claim 5, wherein said slot is wider than a diameter of said fishing line for allowing said fishing line to slide within said slot.

7) The float system of claim 5, wherein said slit has a broad portion and a narrow portion thereby tapering toward said slot.

8) The float system of claim 5, wherein said slit includes a closed portion thereby enclosing said slot, whereby said closed portion may be severed.

9) The float system of claim 5, wherein said open end of said body has a tapered edge.

10) The float system of claim 5, wherein said slit is curved.

11) The float system of claim 5, wherein said hook member further comprises a plurality of holes for attaching additional devices.

12) The float system of claim 1, wherein said elongated member is comprised of a resilient material.

13) The float system of claim 1, wherein said first buoyant member is comprised of a resilient material.

14) The float system of claim 13, wherein said elongated member is comprised of a resilient material.

15) The float system of claim 14, wherein said elongated member is comprised of a buoyant material.

16) The float system of claim 1, wherein said elongated member is comprised of a buoyant material.

17) The float system of claim 16, wherein said elongated member is comprised of a buoyant material.

18) The float system of claim 1, wherein said elongated member further comprises an additional central member slideably attached to said elongated member to permit attachment of a signaling member.

19) The float system of claim 1, wherein said elongated member further comprises an additional central member slideably attached to said elongated member to permit extended length of said elongated member.
